(19) United States
(12) Patent Application Publication
(10) Pub. No.: US 2026/0204788 A1
(43) Pub. Date: Jul. 16, 2026

(54) RADIATING ELEMENT, WAVEGUIDE ANTENNA, AND METHOD FOR MANUFACTURING A RADIATING ELEMENT

(71) Applicant: Robert Bosch GmbH, Stuttgart (DE)

(72) Inventors: Daniel Lopez Cuenca, Stuttgart (DE); Istvan Ther, Budapest (HU); Johannes Meyer, Ettlingen (DE); Julio Alberto Gonzalez Marin, Stuttgart (DE)

(21) Appl. No.: 19/127,875

(22) PCT Filed: Dec. 20, 2023
(86) PCT No.: PCT/EP2023/086915

§ 371 Date: May 7, 2025

(30) Foreign Application Priority Data
Feb. 8, 2023 (DE) 10 2023 200 992.7

(51) Int. Cl. H01Q 13/06

(52) U.S. Cl. CPC H01Q 13/06

(57) ABSTRACT

A radiating element. The radiating element includes a first hollow conductor portion into which an electromagnetic wave is coupled. The first hollow conductor portion extends along a third axis, and has a first rectangular cross-section, a narrow side extending parallel to a first axis, and a wide side extending parallel to a second axis. The radiating element includes a second hollow conductor portion extending along a second axis, and having a second rectangular cross-section, a narrow side extending parallel to the third axis, and a wide side extends parallel to the first axis. A first dimension of the narrow side is smaller than a second dimension of the narrow side. The electromagnetic wave is fed from the first hollow conductor portion into the second hollow conductor portion via a slit in a first region and emitted via an open end of a second region of the second hollow conductor portion.

### FIELD

The present invention relates to a radiating element for a waveguide antenna, a waveguide antenna, and a method for manufacturing a radiating element.

### BACKGROUND INFORMATION

In a hollow conductor or waveguide, electromagnetic energy is transported in a metallic cavity. The hollow conductor may be part of a waveguide antenna, wherein, in the simplest case, a slit is formed in the hollow conductor, which slit serves as an interface between the inner region of the hollow conductor and the free space, i.e., as a radiating element. This slit need not be completely parallel to the currents of the electromagnetic wave running through the hollow conductor.

Since a single slit has only a low directivity, waveguide antennas typically comprise multiple slits that form an antenna array. The simplest way to form a waveguide antenna array is to place the slits on the long side of a rectangular cross-section of the hollow conductor while maintaining a distance of half a wavelength so that a zig-zag structure is created relative to the center of the hollow conductor. Due to the zig-zag structure, all slits radiate with the same phase.

In the serial production of such waveguide antenna arrays using cost-effective methods, two metal parts may be manufactured, which are then assembled. The waveguide channels may be arranged vertically in such cases, wherein the narrow side remains free for radiation. The two parts are connected in parallel with the narrow side of the hollow conductor so that the currents flowing through the hollow conductor are not disrupted. The two metal parts do not even need to have any galvanic contact, so that the guiding capability of the hollow conductor is influenced only marginally.

In order to make possible the required spacing between the radiating elements, U.S. Patent Application Publication No. US 2020/203841 A1 describes a centrally fed open waveguide antenna array, wherein the feeding waveguide is connected to elements formed by two apertures.

### SUMMARY

The present invention provides a radiating element for a waveguide antenna, a waveguide antenna, and a method for manufacturing a radiating element for a waveguide antenna.

Preferred embodiments of the present invention are disclosed herein.

According to a first aspect, the present invention relates to a radiating element for a waveguide antenna. According to an example embodiment of the present invention, the radiating element comprises a first hollow conductor portion, into which an electromagnetic wave may be coupled, wherein the first hollow conductor portion has a first rectangular cross-section, wherein a narrow side of the first rectangular cross-section extends parallel to a first axis, wherein a wide side of the first rectangular cross-section extends parallel to a second axis, wherein the first hollow conductor portion extends along a third axis, and wherein the first to third axes are orthogonal to one another in pairs. The radiating element further comprises a second hollow conductor portion, wherein the second hollow conductor portion has a second rectangular cross-section, wherein a narrow side of the second rectangular cross-section extends parallel to the third axis, wherein a wide side of the second rectangular cross-section extends parallel to the first axis, and wherein the second hollow conductor portion extends along the second axis. A first dimension of the narrow side of the second rectangular cross-section is smaller, in a first region of the second hollow conductor portion, than a second dimension of the narrow side of the second rectangular cross-section in a second region of the second hollow conductor portion. The electromagnetic wave may be fed from the first hollow conductor portion into the second hollow conductor portion via a slit in the first region of the second hollow conductor portion and emitted via an open end of the second region of the second hollow conductor portion.

According to a second aspect, the present invention relates to a waveguide antenna comprising a plurality of radiating elements according to the first aspect of the present invention, and a power splitting device configured to feed an electromagnetic wave into respective first hollow conductor portions of the radiating elements.

According to a third aspect, the present invention relates to a method for manufacturing a radiating element for a waveguide antenna. According to an example embodiment of the present invention, a first hollow conductor portion is formed, into which an electromagnetic wave may be coupled, wherein the first hollow conductor portion has a first rectangular cross-section, wherein a narrow side of the first rectangular cross-section extends parallel to a first axis, wherein a wide side of the first rectangular cross-section extends parallel to a second axis, wherein the first hollow conductor portion extends along a third axis, and wherein the first to third axes are orthogonal to one another in pairs. A second hollow conductor portion is formed, wherein the second hollow conductor portion comprises a second rectangular cross-section, wherein a narrow side of the second rectangular cross-section extends parallel to the third axis, wherein a wide side of the second rectangular cross-section extends parallel to the first axis, and wherein the second hollow conductor portion extends along the second axis. A first dimension of the narrow side of the second rectangular cross-section is smaller, in a first region of the second hollow conductor portion, than a second dimension of the narrow side of the second rectangular cross-section in a second region of the second hollow conductor portion. The electromagnetic wave may be fed from the first hollow conductor portion into the second hollow conductor portion via a slit in the first region of the second hollow conductor portion and emitted via an open end of the second region of the second hollow conductor portion.

The present invention provides independent radiating elements, which may be fed by a power splitting device and then emit electromagnetic radiation.

According to an example embodiment of the present invention, the radiating element comprises a first hollow conductor portion, which is used to feed the electromagnetic radiation into a second hollow conductor portion. The feeding occurs laterally into the slit in the first region of the second hollow conductor portion, i.e., perpendicular to the radiating aperture, which is formed by the opening of the second hollow conductor portion.

This allows a compact design of the waveguide antenna to be achieved, since multiple radiating elements may be arranged adjacent to one another within a short distance.

The radiating element is compact in design and allows for broad impedance adjustment from a vertical power splitting device to the radiating element via impedance transformation in the vertical dimension by means of the different dimensions of the narrow side with respect to the first region and the second region.

The first dimension and the second dimension of the narrow side of the second rectangular cross-section correspond to parameters, which may be suitable for impedance adjustment in the frequency range of electromagnetic radiation used. The dimension of the wide side of the second rectangular cross-section and the dimension of the extension of the second hollow conductor portion along the second axis correspond to further parameters.

Dimensions are to be understood as the respective lengths.

According to a further embodiment of the radiating element of the present invention, the second hollow conductor portion comprises a third region between the first region of the second hollow conductor portion and the second region of the second hollow conductor portion, wherein a dimension of the narrow side of the second rectangular cross-section increases linearly in the third region from the first dimension to the second dimension. The linear increase, which may be expressed by an angle, represents a further parameter that may be used for impedance adjustment.

According to a further embodiment of the radiating element of the present invention, three lateral surfaces of the second hollow conductor portion are planar. For example, the second hollow conductor portion may be L-shaped.

According to a further embodiment of the radiating element of the present invention, the slit in the first region of the second hollow conductor portion is offset along the third axis with respect to a center of the second hollow conductor portion. The dimension of the offset corresponds to another parameter for impedance adjustment.

According to a further embodiment of the radiating element of the present invention, a dimension of the wide side of the second rectangular cross-section is greater than or equal to one half of the wavelength of the electromagnetic wave and less than or equal to three quarters of the wavelength of the electromagnetic wave, for a given field of application.

According to a further embodiment of the radiating element of the present invention, an extension of the second region of the second hollow conductor portion along the second axis is less than or equal to one quarter of the wavelength of the electromagnetic wave.

According to a further embodiment of the method of the present invention for manufacturing the radiating element for a waveguide antenna, the second hollow conductor portion comprises a third region between the first region of the second hollow conductor portion and the second region of the second hollow conductor portion, wherein a dimension of the narrow side of the second rectangular cross-section increases linearly in the third region from the first dimension to the second dimension.

According to a further embodiment of the method of the present invention of manufacturing the radiating element for a waveguide antenna, three lateral surfaces of the second hollow conductor portion are planar.

Further advantages, features and details of the present invention are evident from the following description, in which different embodiment examples of the present invention are described in detail with reference to the figures.

### BRIEF DESCRIPTION OF THE DRAWINGS

FIG. 1 shows a schematic cross-sectional view of a waveguide antenna with radiating elements according to an example embodiment of the present invention.

FIG. 2 shows an oblique schematic view from above of a radiating element according to an example embodiment of the present invention.

FIG. 3 shows a further oblique schematic view from above of the radiating element shown in FIG. 2.

FIG. 4 shows an oblique schematic view from below of the radiating element shown in FIGS. 2 and 3.

FIG. 5 shows a schematic cross-sectional view of the radiating element shown in FIGS. 2 to 4.

FIG. 6 shows a schematic cross-sectional view of a radiating element according to a further example embodiment of the present invention.

FIG. 7 shows an exploded schematic view of a radiating element according to a further example embodiment of the present invention.

FIG. 8 shows a flow chart of a method for manufacturing a radiating element for a waveguide antenna according to an example embodiment of the present invention.

In all figures, identical or functionally identical elements and devices are provided with the same reference signs. The numbering of method steps is for the sake of clarity and is generally not intended to imply a specific chronological order. It is in particular also possible to carry out multiple method steps simultaneously.

### DETAILED DESCRIPTION OF EXAMPLE EMBODIMENTS

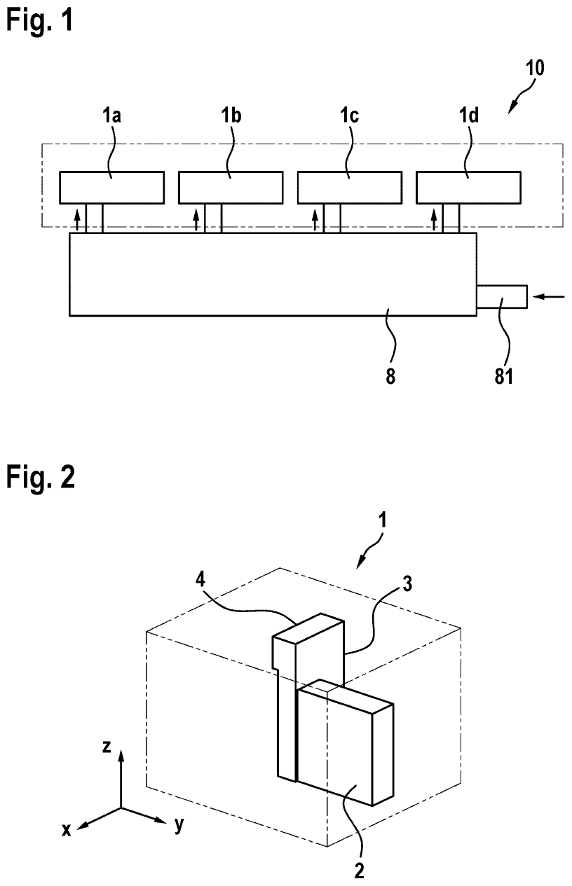

FIG. 1 shows a schematic cross-sectional view of a waveguide antenna 10 comprising a power splitting device 8 and four radiating elements 1a-1d. The power splitting device 8 comprises an input 81, which is supplied with an electromagnetic signal. The power of the electromagnetic signal is split by the power splitting device 8 and the four radiating elements 1a-1d are fed with respective electromagnetic signals. The amplitudes and phase relationships for the individual radiating elements 1a-1d may be adjusted by means of the construction and dimensions of the power splitting device 8.

The present invention is not limited to a certain number of radiating elements 1a-1d.

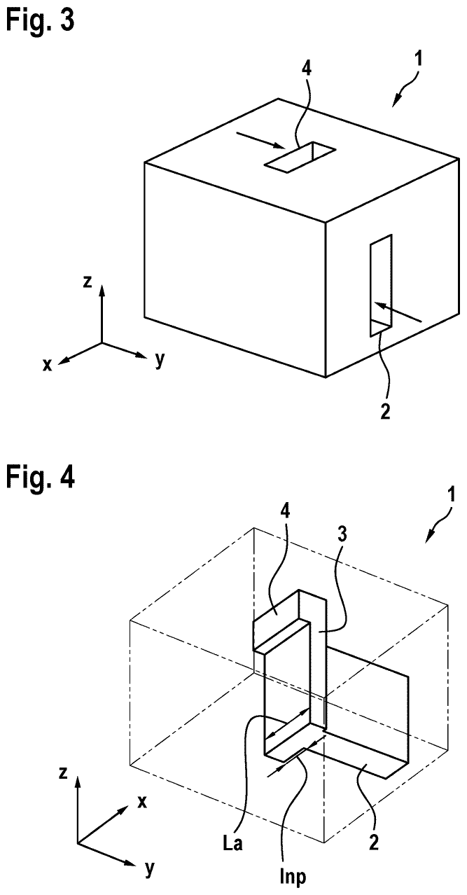

FIG. 2 shows an oblique schematic view from above of a radiating element 1, wherein the hollow conductors are illustrated. FIG. 3 shows a further schematic view of the radiating element 1 shown in FIG. 2, wherein the housing is illustrated. FIG. 4 shows an oblique schematic view from below of the radiating element 1 shown in FIGS. 2 and 3, wherein the hollow conductors are again illustrated.

The radiating element 1 comprises a first hollow conductor portion 2, into which an electromagnetic wave may be coupled. The first hollow conductor portion is cuboidal in shape, thus having a constant first rectangular cross-section, wherein a narrow side of the first rectangular cross-section extends parallel to a first axis X, and wherein a wide side of the first rectangular cross-section extends parallel to a second axis Z. The first hollow conductor portion extends along a third axis Y. The first to third axes X, Y, Z are orthogonal to one another in pairs.

The radiating element 1 further comprises a second hollow conductor portion 3, 4, wherein the second hollow conductor portion 3, 4 has a second rectangular cross-section. A narrow side of the second rectangular cross-section is parallel to the third axis Y. A wide side of the second rectangular cross-section is parallel to the first axis X. The second hollow conductor portion 3, 4 extends along the second axis Z. The second rectangular cross-section varies along the extension of the second hollow conductor portion 3, 4 along the second axis Z. In a first region 3, the narrow side of the second rectangular cross-section has a constant first dimension (width), which is smaller than a constant second dimension of the narrow side of the second rectangular cross-section in a second area 4 of the second hollow conductor portion 3, 4.

Three lateral surfaces of the second hollow conductor portion 3, 4 are planar, i.e., the second hollow conductor portion 3, 4 is L-shaped.

The first region 3 of the second hollow conductor portion 3, 4 comprises a slit extending along the second axis Z and corresponding to the first rectangular cross-section. The electromagnetic wave may be fed from the first hollow conductor portion 2 into the first region 3 of the second hollow conductor portion 3, 4 via the slit into the second hollow conductor portion 3, 4. The electromagnetic radiation is then emitted via an open end of the second region 4 of the second hollow conductor portion 3, 4.

The slit in the first region 3 of the second hollow conductor portion 3, 4 is offset along the third axis X with respect to a center of the second hollow conductor portion 3, 4. The slit is arranged at a distance Inp from a side of the first region 3 of the second hollow conductor portion 3, 4.

The wide side of the second rectangular cross-section of the second hollow conductor portion 3, 4 has a length La.

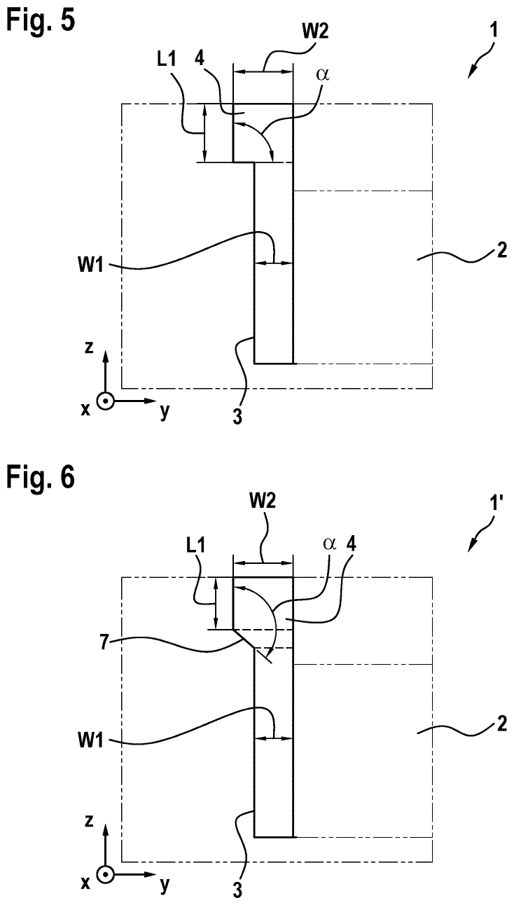

FIG. 5 shows a schematic cross-sectional view of the radiating element 1 shown in FIGS. 2 to 4. With respect to the narrow side of the second cross-section, the second hollow conductor portion 3, 4 comprises a first dimension W1 in the first region 3 of the second hollow conductor portion 3, 4 and comprises a second dimension W2 in the second region 4 of the second hollow conductor portion 3, 4. An angle α of a protruding part of the second region 4 of the second hollow conductor portion 3, 4 is 90 degrees. The second region 4 of the second hollow conductor portion 3, 4 further has a length L1 along the second axis Z.

FIG. 6 shows a schematic view of a radiating element 1′, wherein the angle α is greater than 90 degrees. The second hollow conductor portion 3, 4, 7 thus comprises a third region 7 between the first region 3 of the second hollow conductor portion 3, 4, 7 and the second region 4 of the second hollow conductor portion 3, 4, 7, wherein a dimension of the narrow side of the second rectangular cross-section increases linearly in the third region from the first dimension W1 to the second dimension W2.

Therefore, there are a total of six parameters W1, W2, L1, La, Inp, α, which may be selected for impedance adjustment in the frequency range of the electromagnetic radiation used.

The dimension La of the wide side of the second rectangular cross-section is greater than or equal to one half of the wavelength λ₀ of the electromagnetic wave and less than or equal to three quarters of the wavelength λ₀ of the electromagnetic wave:

$${λ}_{0} / 2 \leq La \leq 3 {λ}_{0} / 4.$$

The extension L1 of the second region 4 of the second hollow conductor portion along the second axis Z is less than or equal to one quarter of the wavelength λ₀ of the electromagnetic wave:

$$L 1 \leq {λ}_{0} / 4.$$

Furthermore, the angle α is greater than or equal to 90 degrees.

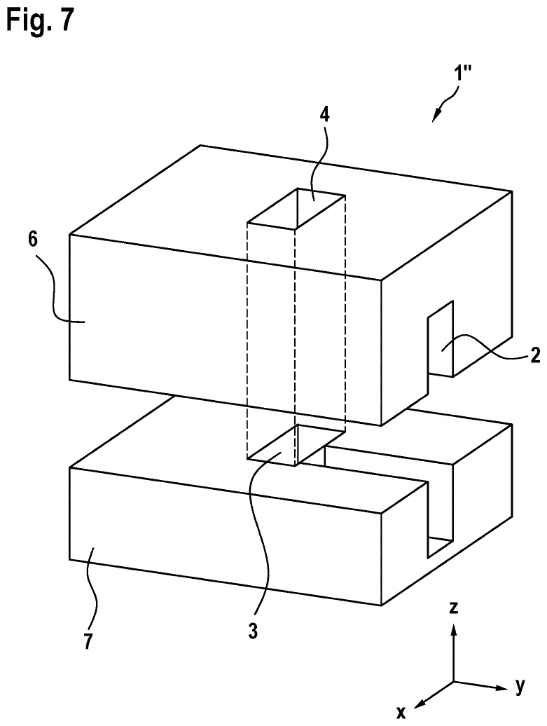

FIG. 7 shows an exploded schematic view of a radiating element 1″. The housing of the radiating element 1″ comprises a first part 6 and a second part 7, which are connected centrally parallel to the first axis X and to the third axis Y. The connection may be non-galvanically formed.

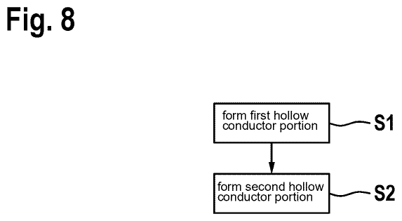

FIG. 8 shows a flow chart of a method for manufacturing a radiating element for a waveguide antenna, in particular one of the radiating elements 1a-1d; 1; 1′; 1″ described above.

In a first method step S1, a first hollow conductor portion 2 is formed, into which an electromagnetic wave may be coupled, wherein the first hollow conductor portion 2 comprises a first rectangular cross-section, wherein a narrow side of the first rectangular cross-section extends parallel to a first axis X, wherein a wide side of the first rectangular cross-section extends parallel to a second axis Z, wherein the first hollow conductor portion extends along a third axis Y, and wherein the first to third axes X, Y, Z are orthogonal to one another in pairs.

In a step S2, a second hollow conductor portion 3, 4, 7 is formed, wherein the second hollow conductor portion 3, 4, 7 comprises a second rectangular cross-section, wherein a narrow side of the second rectangular cross-section extends parallel to the third axis Y, wherein a wide side of the second rectangular cross-section extends parallel to the first axis X, and wherein the second hollow conductor portion 3, 4, 7 extends along the second axis Z. A first dimension W1 of the narrow side of the second rectangular cross-section is smaller, in a first region 3 of the second hollow conductor portion 3, 4, 7, than a second dimension W2 of the narrow side of the second rectangular cross-section in a second region 4 of the second hollow conductor portion 3, 4, 7. The electromagnetic wave may be fed from the first hollow conductor portion 2 via a slit in the first region 3 of the second hollow conductor portion 3, 4, 7 into the second hollow conductor portion 3, 4, 7 and emitted via an open end of the second region 4 of the second hollow conductor portion 3, 4, 7.

The second hollow conductor portion 3, 4, 7 may comprise a third 5 region 7 between the first region 3 of the second hollow conductor portion 3, 4, 7 and the second region 4 of the second hollow conductor portion, wherein a dimension of the narrow side of the second rectangular cross-section increases linearly in the third region 7 from the first dimension W1 to the second dimension W2.

1-10. (canceled)

11. A radiating element for a waveguide antenna, comprising:
a first hollow conductor portion into which an electromagnetic wave is coupled, wherein the first hollow conductor portion has a first rectangular cross-section, wherein a narrow side of the first rectangular cross-section extends parallel to a first axis, a wide side of the first rectangular cross-section extends parallel to a second axis, and wherein the first hollow conductor portion extends along a third axis, and wherein the first, the second, and the third axes are orthogonal to one another in pairs; and
a second hollow conductor portion having a second rectangular cross-section, wherein a narrow side of the second rectangular cross-section extends parallel to the third axis, a wide side of the second rectangular cross-section extends parallel to the first axis, and wherein the second hollow conductor portion extends along the second axis;
wherein a first dimension of the narrow side of the second rectangular cross-section is smaller, in a first region of the second hollow conductor portion, than a second dimension of the narrow side of the second rectangular cross-section in a second region of the second hollow conductor portion; and
wherein the electromagnetic wave may be fed from the first hollow conductor portion into the second hollow conductor portion via a slit in the first region of the second hollow conductor portion and emitted via an open end of the second region of the second hollow conductor portion.

12. The radiating element according to claim 11, wherein the second hollow conductor portion includes a third region between the first region of the second hollow conductor portion and the second region of the second hollow conductor portion, wherein a dimension of the narrow side of the second rectangular cross-section increases linearly in the third region from the first dimension to the second dimension.

13. The radiating element according to claim 11, wherein three lateral surfaces of the second hollow conductor portion are planar.

14. The radiating element according to claim 11, wherein the slit is offset in the first region of the second hollow conductor portion along the third axis with respect to a center of the second hollow conductor portion.

15. The radiating element according to claim 11, wherein a dimension of the wide side of the second rectangular cross-section is greater than or equal to one half of a wavelength of the electromagnetic wave and less than or equal to three quarters of the wavelength of the electromagnetic wave.

16. The radiating element according to claim 11, wherein an extension of the second region of the second hollow conductor portion along the second axis is less than or equal to one quarter of a wavelength of the electromagnetic wave.

17. A waveguide antenna, comprising:
a plurality of radiating elements, each including:
a first hollow conductor portion into which an electromagnetic wave is coupled, wherein the first hollow conductor portion has a first rectangular cross-section, wherein a narrow side of the first rectangular cross-section extends parallel to a first axis, a wide side of the first rectangular cross-section extends parallel to a second axis, and wherein the first hollow conductor portion extends along a third axis, and wherein the first, the second, and the third axes are orthogonal to one another in pairs, and
a second hollow conductor portion having a second rectangular cross-section, wherein a narrow side of the second rectangular cross-section extends parallel to the third axis, a wide side of the second rectangular cross-section extends parallel to the first axis, and wherein the second hollow conductor portion extends along the second axis,
wherein a first dimension of the narrow side of the second rectangular cross-section is smaller, in a first region of the second hollow conductor portion, than a second dimension of the narrow side of the second rectangular cross-section in a second region of the second hollow conductor portion, and
wherein the electromagnetic wave may be fed from the first hollow conductor portion into the second hollow conductor portion via a slit in the first region of the second hollow conductor portion and emitted via an open end of the second region of the second hollow conductor portion; and
a power splitting device configured to feed the electromagnetic wave into the first hollow conductor portions of the radiating elements.

18. A method for manufacturing a radiating element for a waveguide antenna, comprising the following steps:
forming a first hollow conductor portion into which an electromagnetic wave can be coupled, wherein the first hollow conductor portion has a first rectangular cross-section, wherein a narrow side of the first rectangular cross-section extends parallel to a first axis, a wide side of the first rectangular cross-section extends parallel to a second axis, wherein the first hollow conductor portion extends along a third axis, and wherein the first to third axes are orthogonal to one another in pairs; and
forming a second hollow conductor portion having a second rectangular cross-section, wherein a narrow side of the second rectangular cross-section extends parallel to the third axis, a wide side of the second rectangular cross-section extends parallel to the first axis, and wherein the second hollow conductor portion extends along the second axis;
wherein a first dimension of the narrow side of the second rectangular cross-section is smaller, in a first region of the second hollow conductor portion, than a second dimension of the narrow side of the second rectangular cross-section in a second region of the second hollow conductor portion; and
wherein the electromagnetic wave may be fed from the first hollow conductor portion into the second hollow conductor portion via a slit in the first region of the second hollow conductor portion and emitted via an open end of the second region of the second hollow conductor portion.

19. The method according to claim 18, wherein the second hollow conductor portion includes a third region between the first region of the second hollow conductor portion and the second region of the second hollow conductor portion, wherein a dimension of the narrow side of the second rectangular cross-section increases linearly in the third region from the first dimension to the second dimension.

20. The method according to claim 18, wherein three lateral surfaces of the second hollow conductor portion are planar.
